(19) United States
(12) Patent Application Publication
(10) Pub. No.: US 2023/0355453 A1
(43) Pub. Date: Nov. 9, 2023

(54) Warning system for nursing beds

(71) Applicant: Jiyang Li, Beijing (CN)

(72) Inventor: Jiyang Li, Beijing (CN)

(21) Appl. No.: 18/223,047

(22) Filed: Jul. 18, 2023

(51) Int. Cl. A61G 7/05

(52) U.S. Cl. CPC A61G 7/05; A61G 2203/70

(57) ABSTRACT

A smart warning system for nursing beds includes a main body shell, a button switch, a control circuit board, a pull-cord switch, a power module and a warning device. The main body shell is secured to a headboard. The control circuit board and the power module are arranged in the main body shell. The pull-cord switch is arranged on the main body shell. The button switch is arranged on the main body shell. The control circuit board is wirelessly connected to the warning device. The warning device includes a voice interaction control module. The voice interaction control module is wirelessly connected to external terminals. There is further provided a pull-cord switch which can be triggered by the user regardless of any position on the bed in an emergency. The voice interaction control module is connected to the Internet of Things, which automatically dials for emergency contact.

### BACKGROUND OF THE INVENTION

### 1. Field of the Invention

The invention relates to medical care and nursing and more particularly to a warning system for nursing beds.

### 2. Description of Related Art

Conventional bedside warnings devices need users to look for buttons or wear emergency alarms when they are used. Most users have existing hidden dangers of disease and are easy to touch the warnings device by mistake. The installation of existing warnings devices is complicated. Most of them need to be embedded in the wall during decoration, which is troublesome to install, disassemble and maintain.

In the process of nursing in the ward, the call device has become an indispensable device. Hospitals are generally equipped with ward call devices, but the existing ward call devices are generally relatively large, not easy to carry, and sometimes when both hands is inconvenient, because the call is not made in time, the nursing staff cannot arrive in time, which affects the recovery of the patient; or when it is inconvenient to make a sound, because there is not corresponding alarm button, which affects the nursing to the patient; or because when the patient is out of the corresponding autonomy ability and body temperature correspondingly changes, nursing staff cannot detect changes in time.

A novel warning device that makes things convenient for patients to call for help in crisis moment is needed now, which can solve the problems referred to above.

### SUMMARY OF THE INVENTION

The invention provides a smart warning system for nursing beds, which solves the problem of lacking a warning device that is timelier and more convenient for patients to operate for giving an alarm by technically transforming the existing care mode of the nursing beds.

In order to achieve the above objective, the technical solution adopted in the invention is: the invention provides a smart warning system for nursing beds, which includes a main body shell, a button switch, a control circuit board, a pull-cord switch, a power module and a warning device. The main body shell is fixedly arranged on a headboard. The control circuit board and the power module are equipped and arranged in main body shell, the pull-cord switch is arranged on the side of the main body shell, a button switch is arranged on the outer surface of the main body shell, the pull-cord switch, the button switch and then power module are electrically connected and arranged to the control circuit board, and the control circuit board is wirelessly connected to the warning device.

Preferably, the power module includes a power/data cable, the control circuit board is provided with a USB (Universal Serial Bus) power interface, one end of the power/data cable is connected to the USB power interface, and the other end of the power/data cable is connected to an external power source.

Preferably, the warning device includes a voice interaction control module, the voice interaction control module is used for playing warning signals by voice and playing voice prompts, and the voice interaction control module is wirelessly connected to external terminals through the Internet of Things.

Preferably, the external terminals include a smart phone, a monitoring module, a lighting module and a smart door lock module.

Preferably, the control circuit board selects the esp8266 serial Wi-Fi module.

Preferably, the pull-cord switch comprises a switch housing, a pull-cord part, a torsion spring assembly, a cam structure, an installation shaft, a conductive metal sheet and metal spring sheets. The cam structure is rotationally installed inside the switch housing through the installation shaft, the installation shaft is provided with a torsion spring assembly, one end of the torsion spring assembly is in contact with the cam structure, the other end of the torsion spring assembly is arranged against the switch housing, and a pull-cord part is fixed on the outer edge of the cam structure. The other end, away from the cam structure, of the pull-cord part passes though the switch housing and fixedly arranges on a headboard. The two metal spring sheets are arranged inside the switch housing, the metal spring sheets are respectively connected to the control circuit board through connecting wires, and the conductive metal sheet is used to electrically connect to the two metal spring sheet to power on circuit setting.

Preferably, the outer side surface of the cam structure is provided with a plurality of live slots and breaker slots which are adjacently arranged, a limiting baffle is arranged between the live slots and the breaker slots on the outer surface of the cam structure, and the metal spring sheets include the first metal spring sheet and the second metal spring sheet, the first metal spring sheet and the second metal spring sheet are respectively connected to the control circuit board through connecting wires, the upper half part of the conductive metal sheet is arranged on the upper surface of the cam structure, the upper half part of the conductive metal sheet is arranged against the first metal spring sheet, the lower half part of the conductive metal sheet is arranged in live slots, when the second metal spring sheet is positioned in breaker slots, the second metal spring sheet is arranged against the limiting baffle, when the second metal spring sheet is positioned in the live slots, the second metal spring sheet is in contact with the lower half part of the conductive metal sheet, and the second metal spring sheet is arranged against the limiting baffle.

Preferably, a hook is installed on the headboard, and the other end of the pull-cord part away from the main body shell is installed on the hook.

Preferably, the pull-cord part is also provided with a pull-cord length adjuster.

The invention has the following advantages and benefits in comparison with the conventional art:

The invention is equipped with a pull-cord switch, which can be triggered by the user regardless of where the user is on the bed in case of emergency, which simplifies the process of finding the button, which is convenient for the user to call for help, and is easy to install and disassemble, and takes up little space.

According to the invention, a hook is installed on the headboard of the nursing bed, and one end of the pull-cord part of the pull-cord switch is tied to the hook position. According to the different materials of the headboard, the hook and the warning device can be selected according to the user's needs to be nailed, glued or clamped on the headboard of the bed, and the installation height and position can also be selected by oneself, which is convenient for users to use.

The invention is equipped with a voice interaction control module connected to the Internet of Things, which can automatically call emergency contacts, and can smartly control monitoring, lighting, door locks and other equipment, and can customize the process through the mobile terminal, which greatly improves the rescue efficiency and guarantees user's personal safety.

The above and other objects, features and advantages of the invention will become apparent from the following detailed description taken with the accompanying drawings.

### BRIEF DESCRIPTION OF THE DRAWINGS

FIG. 1 is a schematic diagram of an installation structure of the invention;

FIG. 2 is a block diagram of a module connection of the invention;

FIG. 3 is a circuit diagram of an ESP8266 circuit of the invention;

FIG. 4 is a schematic diagram of a turned-on warning device of the invention; and

FIG. 5 is a schematic diagram of a pull-cord switch of the invention.

### DETAILED DESCRIPTION OF THE INVENTION

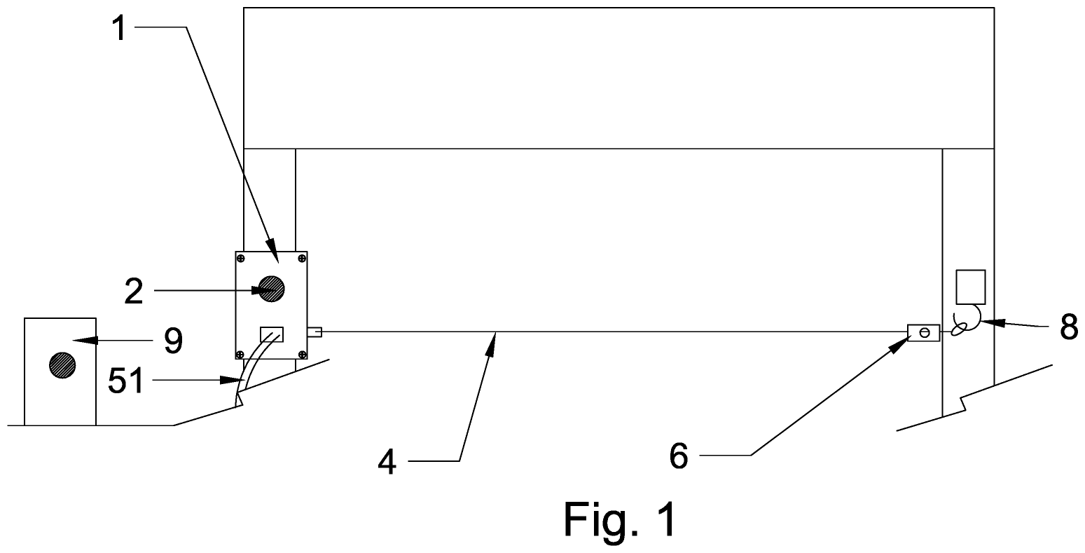

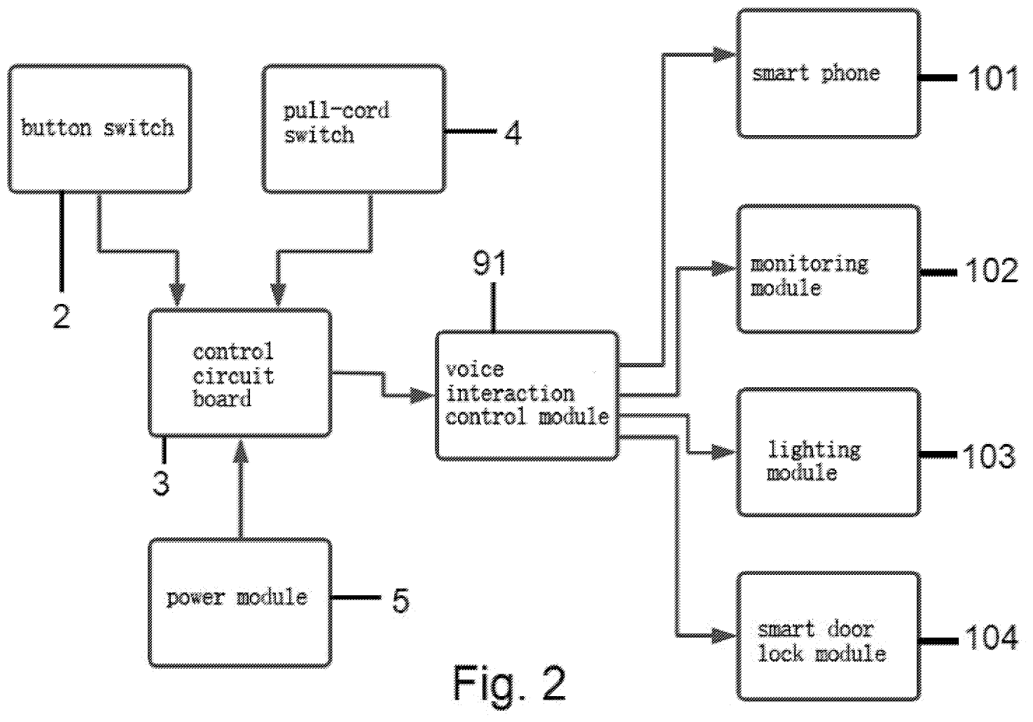

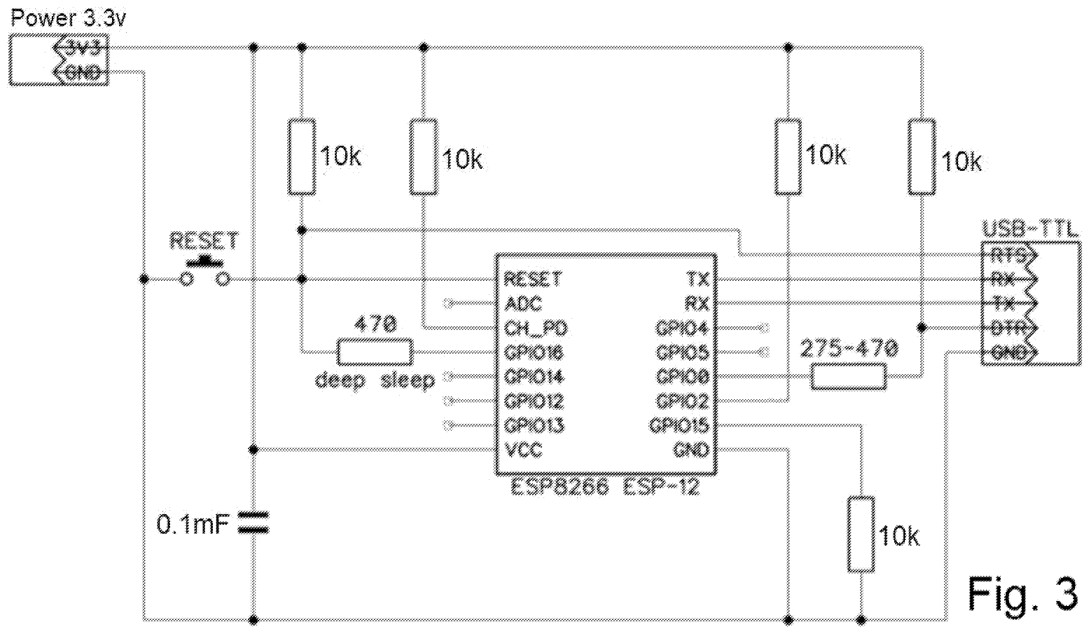

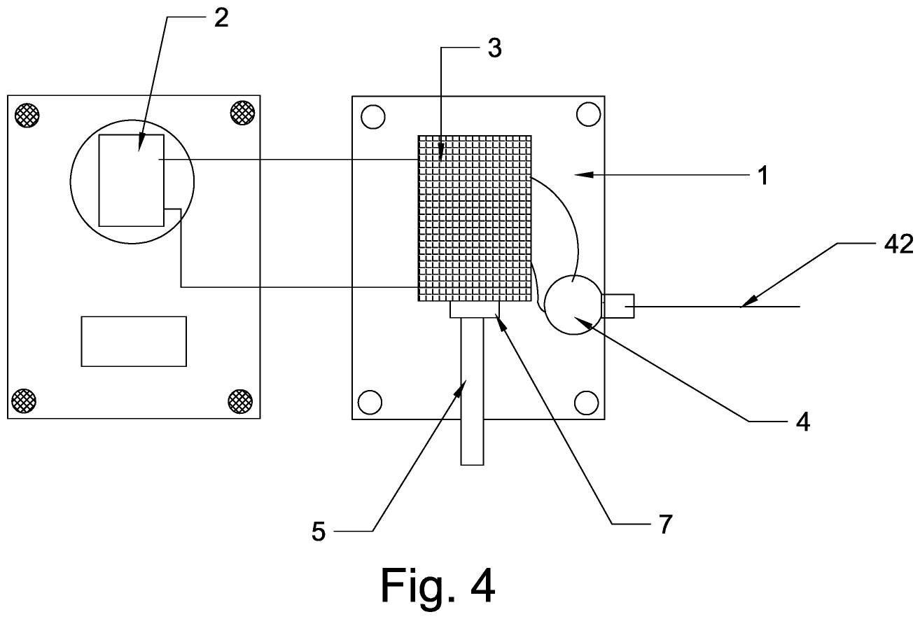

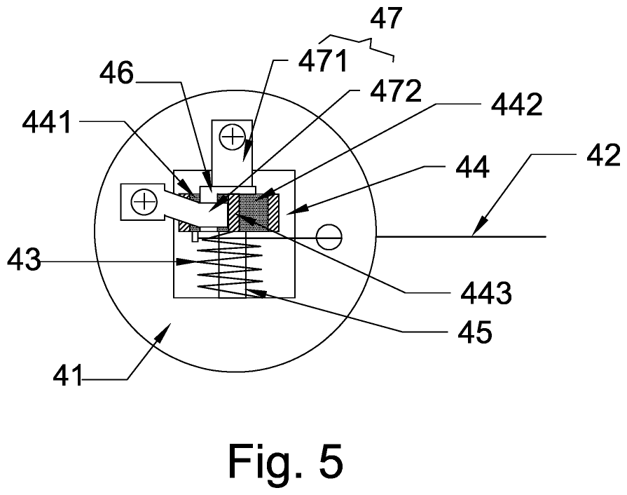

Referring to FIGS. 1-5, a smart warning system for nursing beds of the invention comprises a main body shell 1, a button switch 2, a control circuit board 3, a pull-cord switch 4, a power module 5 and a warning device 9. The main body shell 1 is fixedly arranged on a headboard, the control circuit board 3 and the power module 5 are installed in the main body shell 1, the side of the main body shell 1 is provided with the pull-cord switch 4, the outer surface of the main body shell 1 is provided with the button switch 2, the pull-cord switch 4, the button switch 2 and the power module 5 are electrically connected to the control circuit board 3, and the control circuit board 3 is wirelessly connected to the warning device 9.

The main body shell includes a front cover and a back cover, the front cover and the back cover are detachably connected by fixing screws, and the button switch 2 is arranged on the front cover.

The pull-cord switch 4 is arranged at the headboard position, which is convenient for the patient to trigger at any position on the bed in an emergency, and simplifies the process of finding the button.

Further, in order to provide power to the warning device 9 conveniently, the power module 5 includes a power/data cable 51, the control circuit board 3 is provided with a USB power interface 7, one end of the power/data cable 51 is connected to the USB power interface 7, and the other end of the power/data cable 51 is connected to an external power source.

Further, the warning device 9 includes a voice interaction control module 91, the voice interaction control module 91 is used for playing warning signals by voice and playing voice prompts, and the voice interaction control module 91 is wirelessly connected to external terminals through an Internet of Things platform.

The voice interaction control module 91 selects existing smart speaker and smart voice assistants, such as Alexa, and is connected to external terminal smart devices through the Internet of Things. The design of this application uses the Internet of Things and Alexa as the medium. It is easy to install, adopts a concealed design, and can customize the process, such as automatically calling the emergency contact after triggering, turning on the surveillance video, lighting, and unlocking the smart door lock, which is convenient for rescue.

Further, the external terminals include a smart phone 101, a monitoring module 102, a lighting module 103 and a smart door lock module 104.

The external terminals are connected to the Internet of Things platform through the voice interaction control module 91. After receiving the alarm signal sent by the triggered warning, automatic dialing is achieved through the Internet of Things, and the emergency contact number is dialed. At the same time, the monitoring module in the same cloud platform environment can be controlled to open. Carrying out video surveillance, controlling and turning on the light module to facilitate lighting, turning on the smart door lock module, and turning on the door to facilitate rescue. And it can customize the process through the APP on the mobile phone, which is convenient to control each smart terminal device to unlock automatically, and it is convenient to rescue patients.

Preferably, the control circuit board selects an ESP8266 serial Wi-Fi module. ESP8266 is a powerful Wi-Fi module developed by ESPRESSIF SYSTEMS, which can realize the function of communicating with the network. ESP8266 is widely used in the Internet of Things and can be connected to microcontrollers such as Arduino through a serial communication interface to realize application scenarios such as smart home, smart lighting, and smart vehicles. ESP8266 can be used to control smart lights, smart curtains, smart door locks and other home devices.

The use of ESP8266 is very simple, just need a few steps: connecting ESP8266: connecting the ESP8266 to the microcontroller's serial communication interface; setting up Wi-Fi: setting the Wi-Fi connection information of ESP8266 through AT commands; connecting to the server: connecting to the server through AT commands to realize communication with the server; sending data: sending data to the server by AT command; and receiving data: receiving data from server by AT command.

Further, in order to achieve the switch control effect of the pull-cord switch 4, the pull-cord switch 4 includes a switch housing 41, a pull-cord part 42, a torsion spring assembly 43, a cam structure 44, a mounting shaft 45, a conductive metal sheet 46 and metal spring sheets 47, the cam structure 44 is rotationally installed inside the switch housing 41 through the installation shaft 45, and the torsion spring assembly 43 is arranged on the installation shaft 45, one end of the torsion spring assembly 43 is connected to the of the cam structure 44, the other end of the torsion spring assembly 43 is arranged against the switch housing 41, the outer edge of the cam structure 44 is fixed with a drawstring part 42, and the other end of the pull-cord part 42 away from the cam structure 44 passes through the switch housing 41 and is fixedly arranged on the headboard. The two metal spring sheets 47 are arranged inside the housing 41, and the metal spring sheets 47 are respectively connected to the control circuit board 3 through connecting wires. The outer surface of the cam structure 44 is provided with a conductive metal sheet 46, and the conductive metal sheet 46 is used for electrically connecting the two metal spring sheets 47 to power on circuit setting.

Further, in order to realize that the switch has two states, which are on and off, the outer surface of the cam structure 44 is provided with a plurality of live slots 441 and breaker slots 442 adjacently arranged. A limiting baffle is arranged between the live slots 441 and the breaker slots 442, the metal spring sheets include a first metal spring sheet 471 and a second metal spring sheet 472, the first metal spring sheet 471 and the second metal spring sheet 472 are respectively connected to the control circuit board through connecting wires, the upper half part of the conductive metal sheet 46 is arranged on the upper surface of the cam structure 44, and the upper half part of the conductive metal sheet 46 is arranged against the first metal spring sheet, the lower half part of the conductive metal sheet 46 is arranged in live slots, when the second metal spring sheet 472 is positioned in the breaker slots 442, the second metal spring sheet 472 is arranged against the limiting baffle 443, when the second metal spring sheet 472 is positioned in the live slots, the second metal spring sheet 472 is in contact with the lower half part of the conductive metal sheet 46, and the second metal spring sheet 472 is arranged against the limit baffle 443.

During use, the cam structure 44 is locked in a certain position under the control of the torsion spring assembly 43, and the second metal spring sheet 472 is located in the breaker slots 442 at this time, and the second metal spring sheet 472 is in against the limiting baffle 443. When the pull-cord part 42 of the pull-cord switch 4 is pulled, the cam structure 44 is driven to rotate relative to the installation shaft 45, so that the second metal spring sheet 472 falls into the live slots 441; and the first metal spring sheet 471 and the second metal spring sheet 472 are connected through the conductive metal sheet 46, they connect the circuit, and send a warning signal through the control circuit board 3.

Further, in order to install the pull-cord part 42 conveniently, a hook 8 is installed and arranged on the headboard, and the pull-cord part 42 is installed on the hook 8 at the other end away from the main body shell 1.

Further, the pull-cord part 42 is also provided with a pull-cord length adjuster 6. The existing pull-cord length adjuster 6 can realize adjusting the pull-cord length, and can release or retract the length of the reel pull-cord through the lock, so that the pull-cord switch 4 is conveniently installed on the headboards of different widths.

This embodiment is provided with a pull-cord switch, which can be triggered by the user regardless of where the user is on the bed in an emergency, which simplifies the process of finding the button and facilitates the user to call for help. It is also easy to install and disassemble, and takes up little space.

In this embodiment, a hook is installed on the headboard of the nursing bed, and one end of the pull-cord part of the pull-cord switch is tied to the hook position. According to the material of the headboard, the hook and the alarm can be nailed, glued or clamped according to user needs on the headboard, the installation height and position can also be selected by users, which is convenient for users to use.

The embodiment is equipped with a voice interaction control module 91 connected to the Internet of Things, which can automatically dial emergency contacts, and can smartly controls monitoring, lighting, door locks and other equipment, and can customizes the process through the mobile terminal, which greatly improves the rescue efficiency and guarantees user's personal safety.

The standard parts used in the invention can be purchased from the market, and the special-shaped parts can be customized according to the instructions and the records of the accompanying drawings. The specific connection methods of each part adopt mature bolts, rivets, welding, etc. in the prior art. Means, machinery, parts and equipment all adopt conventional models in the prior art, and circuit connections adopt conventional connection methods in the prior art, which will not be described in detail here.

In the description of the invention, unless otherwise clearly stipulated and limited, the terms “install”, “connected”, “connection” and “fix” should be interpreted in a broad sense, for example, it can be a fixed connection or a detachable connection, or into one; it can be mechanically or electrically connected; it can be directly connected or connected through an intermediary, and it can be the internal communication of two elements or the interaction relationship between two elements. For those skilled in the art, the specific meanings of the above terms in the invention can be understood in specific situations.

While the invention has been described in terms of preferred embodiments, those skilled in the art will recognize that the invention can be practiced with modifications within the spirit and scope of the appended claims.

What is claimed is:

1. A smart warning system for nursing beds, comprising:
a main body shell;
a button switch;
a control circuit board;
a pull-cord switch;
a power module; and
a warning device,
wherein the main body shell is fixedly arranged in a headboard, the control circuit board and the power module are equipped and arranged in the main body shell, the pull-cord switch is arranged on the side of the main body shell, a button switch is arranged on the outer surface of the main body shell, and the pull-cord switch, the button switch and the power module are electrically connected and arranged to the control circuit board, and the control circuit board is wirelessly connected to the warning device.

2. The smart warning system for nursing beds of claim 1, wherein the power module comprises a power/data cable, the control circuit board is provided with a USB power interface, one end of the power/data cable is connected to the USB power interface, and the other end of the power/data cable is connected to an external power source.

3. The smart warning system for nursing beds of claim 1, wherein the warning device comprises a voice interaction control module, the voice interaction control module is used for playing warning signals by voice and voice prompts, and the voice interaction control module is wirelessly connected to external terminals through the Internet of Things.

4. The smart warning system for nursing beds of claim 3, wherein the external terminals comprise a smart phone, a monitoring module, a lighting module and a smart door lock module.

5. The smart warning system for nursing beds of claim 1, wherein the control circuit board selects an esp8266 serial Wi-Fi module.

6. The smart warning system for nursing beds of claim 1, wherein the pull-cord switch comprises a switch housing, a pull-cord part, a torsion spring assembly, a cam structure, an installation shaft, a conductive metal sheet and metal spring sheets, the cam structure is rotationally installed inside the switch housing through the installation shaft, the installation shaft is provided with the torsion spring assembly, one end of the torsion spring assembly is in contact with the cam structure, the other end of the torsion spring assembly is arranged against the switch housing, the pull-cord part is fixed on the outer edge of the cam structure, the other end, away from the cam structure, of the pull-cord part passes though the switch housing and is fixedly arranged on a headboard, the two metal spring sheets are arranged inside the switch housing, the metal spring sheets are respectively connected to the control circuit board through connecting wires, and the conductive metal sheet is used to electrically connect the two metal spring sheets to power on circuit setting.

7. The smart warning system for nursing beds of claim 6, wherein the outer side surface of the cam structure is provided with a plurality of live slots and breaker slots which are adjacently arranged, a limiting baffle is arranged between the live slots and the breaker slots on the outer surface of the cam structure, the metal spring sheets comprises the first metal spring sheet and the second metal spring sheet, the first metal spring sheet and the second metal spring sheet are respectively connected to the control circuit board through the connecting wires, the upper half part of the conductive metal sheet is arranged on the upper surface of the cam structure, the upper half part of the conductive metal sheet is arranged against the first metal spring sheet, the lower half part of the conductive metal sheet is arranged in the live slots, when the second metal spring sheet is positioned in the breaker slots, the second metal spring sheet is arranged against the limiting baffle, when the second metal spring sheet is positioned in the live slots, the second metal spring sheet is in contact with the lower half part of the conductive metal sheet, and the second metal spring sheet is arranged against the limiting baffle.

8. The smart warning system for nursing beds of claim 6, wherein a hook is installed on the headboard, and the other end of the pull-cord part away from the main body shell is installed on the hook.

9. The smart warning system for nursing beds of claim 8, wherein the pull-cord part is also provided with a pull-cord length adjuster.
